(19) United States
(12) Patent Application Publication
(10) Pub. No.: US 2023/0118254 A1
(43) Pub. Date: Apr. 20, 2023

(54) SYSTEMS AND METHODS FOR PROVIDING REROUTING PRIOR TO DEPARTURE

(71) Applicant: Nexteon Technologies, Inc., Maple Glen, PA (US)

(72) Inventor: Cornelius George Hunter, Cameron Park, CA (US)

(21) Appl. No.: 17/964,749

(22) Filed: Oct. 12, 2022

Related U.S. Application Data
(60) Provisional application No. 63/256,357, filed on Oct. 15, 2021.

(51) Int. Cl. G08G 5/00

(52) U.S. Cl. CPC G08G 5/0039; G08G 5/006; G08G 5/0013; G08G 5/0091

(57) ABSTRACT

A method of providing a rerouting decision is disclosed. The method includes receiving a flight plan route for a flight between a starting location and a destination location, confirming the flight plan route with an air traffic control system, said flight plan route being associated with a gate at the starting location, receiving at least one candidate reroute of the flight between the starting location and the destination location, and accepting the at least one candidate reroutes of the flight plan prior to leaving the gate at the starting location.

### PRIORITY

The present application claims priority to U.S. Provisional Patent Application No. 63/256,357 filed Oct. 15, 2021, the disclosure of which is hereby incorporated by reference in its entirety.

### BACKGROUND

In the United States, the National Airspace System (NAS) serves several tens of thousands of civil transport flights each day, transporting several millions of passengers and significant volumes of cargo. Given the large number of flights, and considerable cost of fuel and time involved, even seemingly minor improvements in flight time and efficiency can yield substantial environmental protection and economic savings.

One source of inefficiency, and opportunity for savings, is the routes used by civil transport flights. Civil transport routes are subject to several complicating factors and constraints, including weather, airspace availability and procedures, traffic management initiatives (TMIs), traffic patterns and congestion, and aircraft performance. These complicating factors and constraints often impose route inefficiencies. One reason for this negative impact is that flight plans are required to be formulated and filed 1-2 hours prior to gate departure, and in practice are often filed up to 12 hours prior to gate departure. In this time window of several hours prior to departure, information and data regarding the complicating factors and constraints can be uncertain or even unavailable. Naturally, the larger the time gap between filing of the flight plan and the actual departure time, the more uncertain the information that is used to formulation that flight plan. As a result, flight plans often are formulated using data that are highly uncertain or simply not available.

The formulation of flight plans with uncertain or unavailable data means that flight plans must be conservative. For example, a significant buffer must be placed around inclement weather systems, such that flight plan routes deviate significantly around that weather. This level of uncertainty means that in most scenarios, the flight plan route requires significantly greater flight time, compared to a theoretical flight that deviates around the weather with a safe but not excessive deviation.

Because routing is both economically important and technically challenging, there remains a need, therefore, for a more efficient air traffic rerouting system.

### SUMMARY

In accordance with an aspect the invention provides a method of providing a rerouting decision. The method includes receiving a flight plan route for a flight between a starting location and a destination location, confirming the flight plan route with an air traffic control system, said flight plan route being associated with a gate at the starting location, receiving at least one candidate reroute of the flight between the starting location and the destination location, and accepting the at least one candidate reroutes of the flight plan prior to leaving the gate at the starting location.

In accordance with another aspect the invention provides a method of providing a rerouting decision that includes confirming a flight plan route for an aircraft for a flight between a starting location and a destination location flight plan route with an air traffic control system, said flight plan route being associated with a gate at the starting location, and receiving at least one candidate reroute of the flight between the starting location and the destination location prior to leaving the gate at the starting location.

In accordance with a further aspect, the invention provides a system for providing a rerouting decision. The system includes a computer processing system for confirming a flight plan route for an aircraft for a flight between a starting location and a destination location flight plan route with an air traffic control system, said flight plan route being associated with a gate at the starting location, and receiving at least one candidate reroute of the flight between the starting location and the destination location prior to leaving the gate at the starting location.

### BRIEF DESCRIPTION OF THE DRAWINGS

The following description may be further understood with reference to the accompanying drawings in which:

FIG. 1 shows an illustrative diagrammatic view of a pre-departure and post-departure phases of a flight plan in accordance with aspect of the present invention;

FIG. 2 shows an illustrative diagrammatic view of information and data sources used in dynamic air traffic routing technology;

FIG. 3 shows an illustrative diagrammatic view of a hierarchy of special activity airspaces;

FIG. 4 shows an illustrative diagrammatic view of counts of days that certain special-us-airspaces are active over a selected period of time;

FIG. 5 shows an illustrative diagrammatic view of an example reroute traffic-management-initiative advisory;

FIG. 6 shows an illustrative diagrammatic view of a sampling of restrictions that include several 15 minute-in-trail restrictions;

FIG. 7 shows an illustrative diagrammatic view of an example airspace-flow-program traffic-advisory-initiative;

FIG. 8 shows an illustrative diagrammatic view of a post-filing pre-departure time window;

FIG. 9 shows an illustrative diagrammatic functional view of the use of data sources for the identification of airspace closures in accordance with an aspect of the present invention;

FIG. 10 shows an illustrative diagrammatic process flow diagram of a route safety assessment process for use in a system in accordance with an aspect of the present invention;

FIGS. 11A-11D show illustrative diagrammatic views of an arrival flight from the northeast that us rerouted to a southeast arrival, showing a non-conformance detected (FIG. 11A), a deviation increasing (FIG. 11B), a further deviation increasing (FIG. 11C), and a reroute implemented (FIG. 11D);

FIGS. 12A-12D show illustrative diagrammatic views of a path stretching reroute, showing aircraft first conforming to a flight plan (FIG. 12A), a non-conformance deviation increasing (FIG. 12B), a reroute implemented (FIG. 12C), and the aircraft conforming to the reroute (FIG. 12D); and

FIG. 13 shows an illustrative diagrammatic view of an example search report for a flight in a system in accordance with an aspect of the present invention.

The drawings are shown for illustrative purposes only.

### DETAILED DESCRIPTION

Applicant has discovered that one way the excessive deviation between a theoretical flight and a flight plan route that requires significantly greater flight time and fuel use, can be reduced is by rerouting the aircraft once it is finally in flight, in the post departure phase. Technologies such as the SmartRoutes tool (as provided by Nexteon Technologies, Inc. of Maple Glenn, Pa.) perform this function. See for example, U.S. Pat. No. 11,348,473, the disclosure of which is hereby incorporated by reference in its entirety. While this post-departure technology provides helpful savings, it is limited by the original choice of route. Even more savings would be available with an improved pre-departure route design that is not excessively conservative.

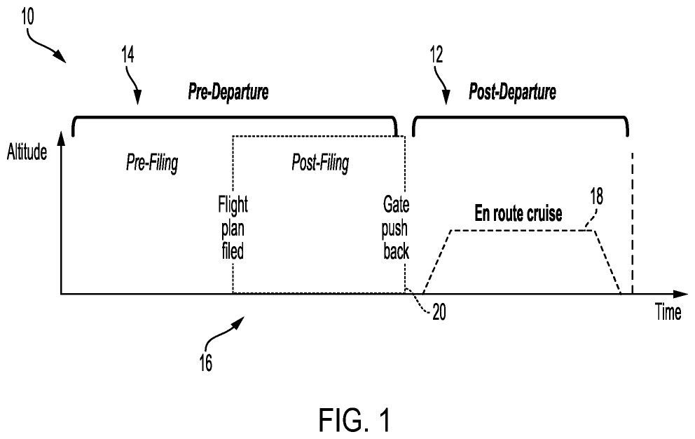

Applicants have discovered that there is further a need for an improved pre-departure flight plan route design technology—a difficult challenge, as discussed above, because the required data are uncertain or even unavailable. It has further been discovered that there is an opportunity to improve route design, after the flight plan has been filed and as the time of departure approaches. To address this opportunity for better efficiency, the pre-departure phase has been divided into the pre-filing and post-filing time windows, as illustrated in FIG. 1, which shows pre-departure (at 10) and post-departure phases (at 12), with pre-departure phase divided into pre- and post-filing time windows (14 and 16). Post departure, the aircraft executes its route as depicted at 18.

In the post flight-plan-filing time window, as the time approaches the departure point, for example within 60 minutes of departure, the various data sources become increasingly accurate and less uncertain. This concept suggests a new dynamic air traffic routing opportunity for which new technology is required, to derive and improve the flight plan route. Such an improved route, derived from substantially improved data (compared to the data used to derive the original flight plan route), would provide potentially significant savings compared to the original flight plan route.

This dynamic air traffic routing technology, applied in the post flight-plan-filing time window, also would provide significant savings compared to post departure rerouting technologies. Therefore, dynamic air traffic routing technologies specifically designed for this post flight-plan-filing time window are the subject of this innovation. FIG. 1 illustrates at 20 this time window of interest, showing the pre-departure, post flight-plan-filing, time window of interest.

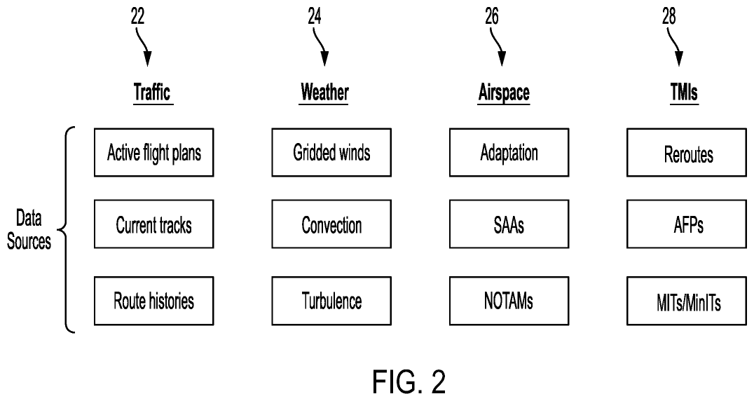

While the data in the post-filing time window are substantially improved compared to the pre-filing window, nonetheless they do contain some degree of uncertainty. The challenge in this pre-departure phase, even in the post-filing window, is to develop new technologies both to (i) handle these uncertainties, and (ii) integrate the disparate and varied information and data types into a single cohesive decision-making tool. FIG. 2 illustrates these disparate information and data sources used in the dynamic air traffic routing technology, showing data sources used in dynamic air traffic routing technology. As FIG. 2 shows, these data sources are divided into the four categories: traffic 22, weather 24, airspace 26, and traffic management initiatives (TMIs) 28. For each category, the system identifies and organizes three key types of data. For the traffic category 28, the system identifies active flight plans, current tracks and route histories. For the weather category 24, the system identifies gridded winds, convection and turbulence. For the airspace category 26, the system identifies adaptation, special-activity-airspaces (SAAs) and notices-to-airmen (NOTAMs). For the traffic-management-initiatives category 28, the system identifies reroutes, airspace-flow-programs (AFPs), miles-in-trail (MITs) and minutes-in-trail (MinITs). A total of 12 different data types is therefore provided. These varied and disparate data types come from different sources, and require new technologies to model them individually, and integrate them corporately.

Proposed data sources and the new modeling technologies are provided herein, as well as summaries of these modeling technologies in the context of the dynamic air traffic routing technology. Additionally, the technologies that integrate these data and their models, into a cohesive whole is provided. These are referred to herein as backend technology components because they perform the data management and calculations that support the user display, or the front-end. Front-end technologies are also discussed herein.

The data sources and new modeling technologies, including the information and data sources used for dynamic air traffic routing, are divided into the four categories discussed above: traffic, weather, airspace, and TMIs. The three key traffic data types are the active flight plans, current aircraft tracks, and routing histories. The dynamic air traffic routing technology requires a knowledge of the current traffic conditions in the national airspace system. One important data source in understanding the traffic conditions is the active flight plans for flights that are both pre-departure and post departure. These flight plans may be obtained from the FAA System-Wide Information Management (SWIM) data source (see https:/www.faa/gov). The system collects, saves, and archives these active flight plans for use in the dynamic air traffic routing technology discussed herein.

While many technologies merely rely on the active flight plans to model current and future traffic conditions, the active flight plans by themselves are in fact insufficient to understand the current traffic conditions for the simple reason that flights often do not conform to their flight plans precisely. Even minor nonconformances may be significant. It is important therefore to obtain aircraft tracking data that indicates this non-conformance. Aircraft tracking data provide the current position and velocity for aircraft (current aircraft tracks) in the post departure phase. A real-time display of aircraft tracks may reveal only a scattered pattern of tracks. Nonconformance modeling technology that reconciles the active flight plans with the real-time aircraft tracks is discussed herein below.

In addition to the current traffic conditions, the traffic data also include a third data type that is the historical routings that aircraft have used in the national airspace system. There is no convenient source of historical routes. The dynamic air traffic routing discussed herein therefore accrues daily route data over a long-time span and constructs the historical routing patterns in the national airspace system. This technology provides the routes that were flown over any specified time window, such as the previous six months or previous year, and so forth. This technology also, in addition to providing the routes, provides the frequency with which each route is flown. This is important as it indicates whether or not a route is rarely used, commonly used, and so forth. These frequency data will be important in using the historical routing data, as described in more detail below.

The three key traffic weather types are the winds, convection, and turbulence. The dynamic air traffic routing technology herein requires a knowledge of the en route winds in order to estimate the flight time of candidate reroutes in accordance with an aspect of the invention. A candidate source of such wind data is the Rapid Refresh product, provided by the National Oceanic and Atmospheric Administration (NOAA). The Rapid Refresh product, or RAP (https://rapidrefresh.noaa.gov), is a continental-scale, hourly-updated meteorological forecast product. The RAP data from NOAA encompasses North America.

The dynamic air traffic routing technology also requires a knowledge of convective weather (e.g., storms) because convection causes turbulence which poses a danger to aircraft in flight in accordance with an aspect of the invention. Consequently, operators avoid heavy convection, resulting in reduced airspace capacity. The combination of convection and traffic that otherwise would use the airspace results in congestion, and the airspace capacity may be insufficient to handle the traffic load, as discussed below. Convection forecasts are available from the NOAA High-Resolution Rapid Refresh (HRRR) product. The HRRR product is a real-time 3-km resolution, hourly updated convection forecast, incorporating radar data every 15 min (https://rapidrefresh.noaa.gov). A faster, 5-min refresh rate is available in the FAA Corridor Integrated Weather System (CIWS) product (see https://www.faa.gov).

In addition to convection, turbulence may also occur outside of convection, whether in proximity to convection or in clear air, hundreds of miles from convection. This may be due to terrain (e.g., mountain ranges causing atmospheric waves), interaction with the jet stream, and so forth. A source of turbulence forecast data is the Graphical Turbulence Guidance Nowcast (GTGN) product, available from the National Center for Atmospheric Research (NCAR) (see https://ral.ucar.edu). The GTGN product updates every 15 minutes and incorporates real-time turbulence observations, including eddy dissipation rate (EDR) measurements made by airborne instruments, turbulence pilot reports, and satellite measurements). The three key traffic airspace types are the adaptation data, special activity airspace (SAAs), and notice to Airmen (NOTAMs).

The FAA provides the National Airspace System adaptation data that describes the geographic boundaries of airspace sectors and Air Route Traffic Control Centers (ARTCCs), and jet routes. The adaptation data are available at the FAA En Route Automation Modernization (ERAM) site (https://www.adx.faa.gov), which shows data from the FAA ERAM ADX site. The ERAM site provides an aeronautical data exchange (ADX) that is a portal-based data source for distributing aeronautical related data to FAA employees, contractors, and DoD personnel. The adaptation data are organized by ARTCC and provided as ERAM ADX adaptation data. The adaptation data are updated at least once per month, and the dynamic air traffic routing technology requires the most up to date adaptation data in order to model airspace closures and congestion in accordance with an aspect of the present invention as discussed further below.

The FAA maintains a diverse set of special activity airspaces (SAA) in the National Airspace System. The special activity airspaces affect dynamic routing because airspaces may be restricted and closed to commercial traffic during, for example certain calendar dates and time windows. The dynamic air traffic routing technology therefore requires current knowledge of all SAA status, which requires new technology, as SAA status updates are not always readily available to flight planners.

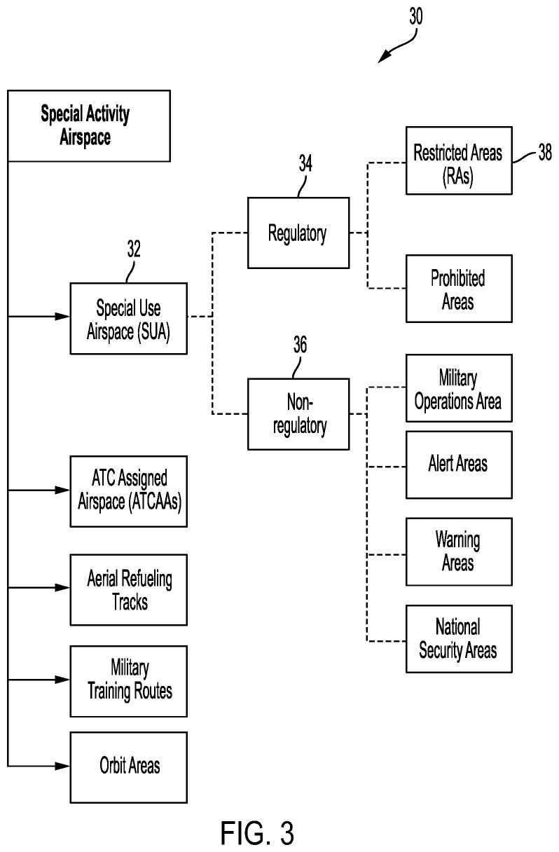

Special activity airspace includes several categories, including special use airspace (SUA), air traffic control assigned airspace (ATCAAs), aerial refueling tracks, military training routes, and orbit areas. Of the different SAA categories, SUAs form a large subset. Further, there are two categories of special use airspace: regulatory and non-regulatory. Regulatory SUAs consist of restricted areas and prohibited areas. Non-regulatory SUAs include military operations area (MOA), alert areas, warning areas and national security areas. FIG. 3 shows at 30 the hierarchy of SAAs that include the above five categories, showing the special use airspace (SUA) 32 including groups of regulatory 34 and non-regulatory 36 airspaces. Of these SUA categories and subcategories, and restricted areas (RAs) 38 are the most relevant to ATM. The controlling agency may not authorize aircraft operations in restricted areas if the RA is still active and is yet to be released to the controlling agency. Dynamic planning of flight trajectories is possible when real-time status updates for restricted areas become available to the controlling agency.

Although SUA boundaries vary infrequently, daily updates to their active altitude range and active time durations are not uncommon. The FAA provides daily SAA activity status updates that provide information regarding FAA SAA daily updates in, for example, a geographic depiction (see http://sua.faa.gov). Users may zoom in on an area of interest to obtain additional detail, for example showing SAA daily update details. In addition to the graphical representation of delay, textual information regarding SAA daily updates is available as well.

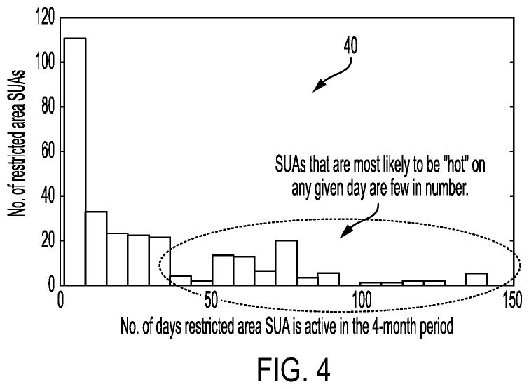

The textual data include, SAA type, including for example, W for warning areas and R for restricted areas, SAA airspace ID, SAA start time and end time in coordinated universal time (UTC), the ARTCC and state associated with the airspace, as well as active SAA altitude floors and ceilings expressed either as flight levels (hundreds of feet above mean sea level) or when marked by an asterisk, in thousands of feet above ground level (AGL). Most SAAs are not typically active, and that associated airspace is therefore available to commercial traffic. For SUAs, count days regarding days that a restricted area is active, may be relatively small. For example, FIG. 4 shows at 40 count of days that restricted area SUAs are active, showing that over a representative four-month period, most SUAs were active in only one or a few days. FIG. 4 shows the impact of SAAs on commercial traffic, with example of traffic avoidance of Restricted Area SUAs. The dynamic air traffic routing disclosed herein collects these SAA data in real-time and models the temporal and spatial active status, for use in determining if a candidate route is available or not.

The notice to airmen (NOTAM) advisories are alerts of temporarily closed or hazardous airspace, or other important information, for national airspace users. Users may search for NOTAMs relevant to their operations at the FAA website regarding NOTAMs, which includes data regarding traffic avoidance of restricted area SUAs (see https://notams.aim.faa.gov). The NOTAM information may be graphical or textual. In either case, the information is parsed and modelled into usable digital data that can be integrated into the dynamic air traffic routing technology disclosed herein.

The special activity airspaces are a complicated constraint on the national airspace because they have varying time limits and altitude limits. Another type of constraint that further complicates the process are the traffic management initiatives (TMIs). The traffic management initiatives are more complicated than SAAs because their horizontal (latitude and longitude) boundaries can be scenario-dependent rather than being simply a static polygon, and they often pose a complicated, scenario-dependent, capacity reduction rather than a complete airspace closure. The three key TMI types are reroutes, airspace flow programs (AFPs), miles-in-trail (MITs) and minutes-in-trail (MinITs).

Several different types of events in the national airspace system may restrict flights from using their preferred route, and instead require flying a reroute. For example, in a heavy weather day, air traffic control service providers and airspace users may collaborate in selecting a severe weather avoidance plan (SWAP) from the national playbook. A severe weather avoidance plan designates a particular routing strategy to be used that day. Alternatively, in response to the development of regional convective weather, service providers may initiate an integrated collaborative rerouting (ICR) constraint, forcing users to route around a designated flow constrained area (FCA). On the other hand, growing traffic congestion in airspace sectors may result in tactical reroutes intended to relieve the congestion, or a rocket launch may cause the closure of airspace to commercial users.

The traffic-management-initiatives may leave users with little choice of which route to file, or users may have the option to select from several possible routes. Furthermore, rather than forcing users away from their preferred route, TMIs might merely make the route less desirable by adding delay. Given that several different types of data, with different sources, may cause reroutes, the reroute information can be difficult to obtain, in its totality. Further, given that several different types of events may cause reroutes, an accurate modeling and understanding of the complete reroute scenario can be difficult for users to construct. The dynamic air traffic rerouting technology in accordance with an aspect of the present invention solves this problem for users such as airline dispatchers who, otherwise, have no more than approximately 30 sec to make rerouting decisions for a flight in the post-filing, pre-departure time window. Some rerouting information can be obtained from the FAA NAS Status Board, which provides data regarding active airport events (see https://nasstatus.faa.gov).

One of several important types of reroute information available on the NAS status board is the current reroutes, which may include an NAS status board reroutes tab providing ATC SCC advisories. The current reroutes summarizes active reroute advisories in the national airspace system. For example, details include example reroute TMI advisories.

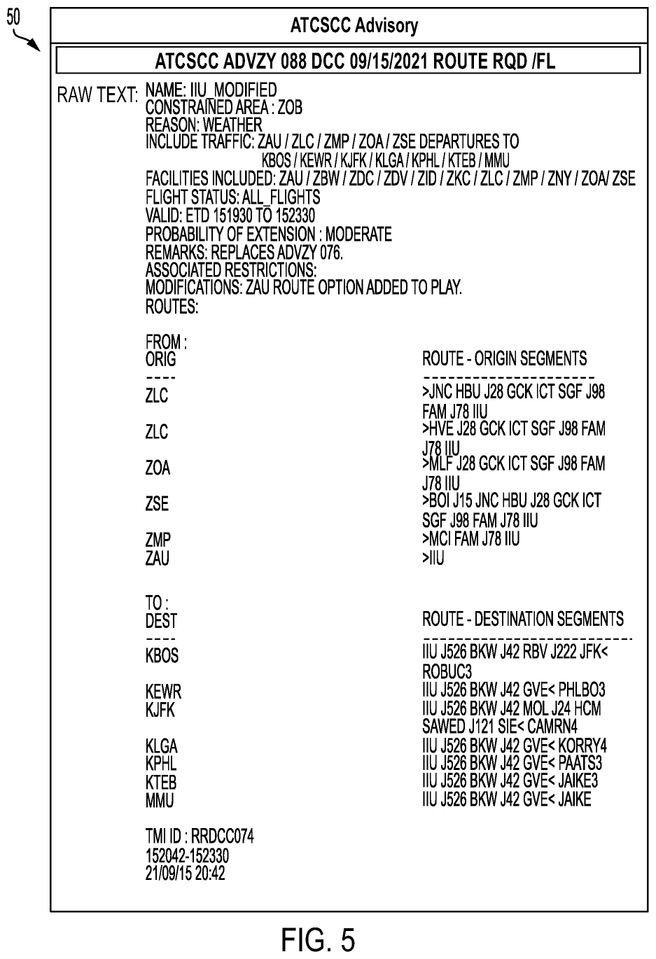

In particular, FIG. 5 shows at 50 an example reroute TMI due to heavy weather in ZOB (Cleveland ARTCC). The TMI specifies both the origin and destination airports of affected flights. This information is important to have in considering a reroute decision in the post-filing pre-departure time window. The dynamic air traffic rerouting technology in accordance with an aspect of the present invention collects, parses, and models all such current reroutes, for use in deriving the optimal rerouting decision. Another type of reroute TMI is the coded departure routes (CDRs) which avoid inclement weather in the extended terminal area of the departure airport. The coded department routes typically take users off their preferred route, but users may request to transition back to their preferred route once they have flown past the heavy weather. The CDRs are found in the route management tool (RMT) at the FAA air traffic control system command center (ATCSCC) (see http://www.fly.faa.gov). The ATCSCC site provides data regarding CDRs for origin and destination pairs. These CDRs are the reroutes that a flight may be reassigned to by air traffic control. The CDRs are yet more rerouting data that the dynamic air traffic rerouting technology of systems of certain aspects of the present invention collect, parse, and model, to support the post-filing, pre-departure rerouting decision. Also, at the FAA ATCSCC provides the national playbook SWAPs (see http://www.fly.fee.gov), showing, for example, a particular routing structure with SWAP information. All of these rerouting TMIs are collected, parsed, and modeled in the dynamic air traffic rerouting technology.

The initiatives miles-in-trail (MIT) and minutes-in-trail (MinIT) are further types of TMIs used for managing airspace congestion that may be due to heavy weather, heavy traffic, or a combination of the two. When emerging airspace congestion becomes significant, posing a risk of the traffic load exceeding the airspace capacity (accounting for weather-caused degradation of airspace capacity), then a flow constrained area (FCA), which typically is a line drawn across traffic flows contributing to the congestion, is used to manage the traffic load. The MIT initiatives and MinIT initiatives are TMIs used to perform such management. These two TMIs specify the minimum miles and minimum minutes, respectively, between consecutive flights on the same route, passing through the FCA.

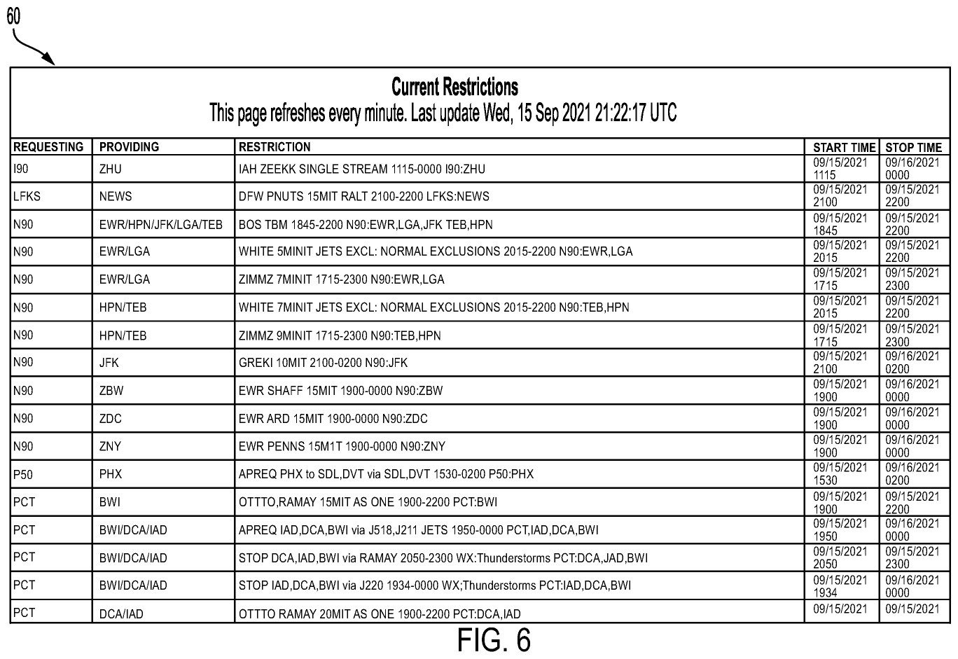

The MIT and MinIT initiatives re examples of TMIs that do not close airspace or otherwise force flights to select a reroute. Instead, they require that the user choose a user-preferred route that is less desirable by adding delay. Also, a subtlety that the dynamic air traffic rerouting technology provides accounts for is that the MIT and MinIT initiatives may cause other traffic to select reroutes, thus alleviating the traffic flow through the FCA and, ultimately, the need for the MIT or MinIT. In that case, the preferred route may not be penalized, and it is in the user's interest not to refile with an alternate route, but to stay the course. FIG. 6 shows an example sampling of current restrictions showing MIT and MinIT TMI restrictions. FIG. 6 shows at 60 many restrictions that include several MIT initiatives at 15 MIT, which is fairly significant. Note that other restrictions in FIG. 6 are minutes in trail (MinIT).

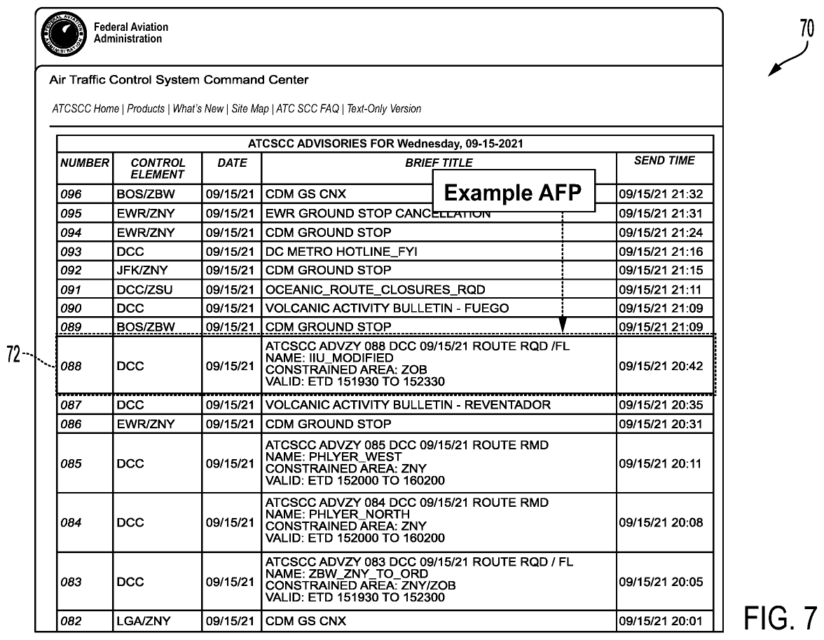

Another type of initiative includes airspace flow programs (AFPs) that are used for managing airspace congestion. As with MIT and MinIT TMIs, AFPs are used for managing airspace congestion that may be due to heavy weather, heavy traffic, or a combination of the two. But whereas MIT and MinIT TMIs are relatively fine-grade tools, AFPs are capable of more significant reduction in the traffic loading. AFPs achieve this reduction by identifying specific flights in the problematic flows and requiring them to undergo a pre-departure delay known as an expect departure clearance times (EDCT). The EDCTs are powerful mechanisms for metering traffic through an FCA, and users can view EDCTs that their flights have been assigned in the NAS Status Board site. AFPs are listed in the FAA ATCSCC site discussed above, as shown at 70 in FIG. 7, which shows at 72 an example AFP TMI.

The dynamic air traffic rerouting technology disclosed herein accounts for AFPs, potential upcoming AFPs that may be declared, and pre-departure reroute decisions that users may file, in order to avoid being assigned and EDCT. The AFPs may provide candidate reroutes for users to select from. The dynamic air traffic rerouting technology also considers the strategy of flying under or over an AFP. This strategy results in less efficient flight (because the aircraft is not flying at its most efficient altitude) but can avoid the EDCT. The Dynamic Air Traffic Rerouting technology also accounts for the fact that EDCTs assigned as a result of an AFP have lower priority than, and thus are overridden by, any departure delays due to a ground stop (GS) or ground delay program (GDP).

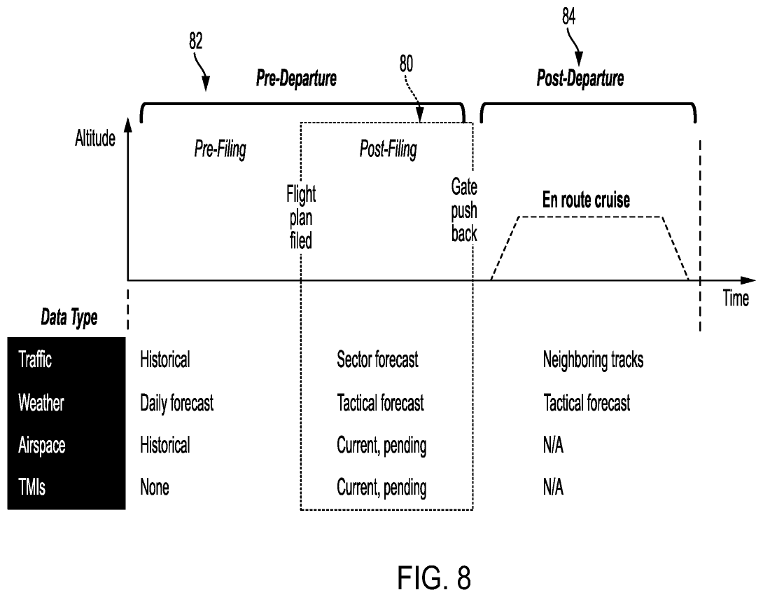

The information and data in each of the four categories required by the dynamic air traffic rerouting technology discussed herein derive from disparate sources and require different and varied parsing and modeling technologies in order to integrate the data into the post-filing pre-departure decision support system. While it is theoretically possible to collect these data and model them, in practice it is not practical or even feasible for users such as the airline dispatcher to perform this task in any meaningful way, especially given a dispatcher's significant workload. In practice dispatchers are limited to approximately 30 sec for any particular decision regarding a flight. Therefore, it is exceedingly difficult for such users to construct and formulate a quantitative scenario, incorporating all these different data sources and how they integrate together into a post-filing pre-departure decision making framework. On the other hand, this time period provides a unique opportunity to improve aviation safety, as illustrated in FIG. 8, which shows at 80 the post-filing pre-departure time window unique opportunity.

FIG. 8 shows that the post-filing pre-departure window 80 exists after a flight plan is filed (after pre-filing as shown at 82) and prior to the aircraft pushing back from the gate (prior to post-departure as shown at 84). The traffic data type that may be evaluated includes sector forecast, the weather data type that may be evaluated includes tactical forecast, and current and pending airspace and TMI datatypes may also be evaluated. The pre-filing time window is comprised of highly uncertain or unavailable data (because it is a long time before the flight departure), and the post-departure time window is comprised of lost opportunity (because the flight route has been committed to). The post-filing pre-departure time window however, provides the unique opportunity of relatively complete and accurate flight-relevant data combined with the opportunity to reroute. This opportunity is addressed by the dynamic air traffic rerouting technology disclosed herein.

The backend technology components of the dynamic air traffic rerouting technology include data storage devices that include the above discussed data. In these components, the data sources and models described above are integrated, to develop the dynamic air traffic rerouting decision-making technology. At the highest level, the system performs four major tasks: 1) collect, parse, and model a large number of data streams; 2) for a given flight, identify all possible, candidate, routing choices; 3) evaluate the routing choices; and 4) provide routing guidance to airspace users via a graphical user interface. The backend technology focuses on tasks 2 and 3 as discussed below.

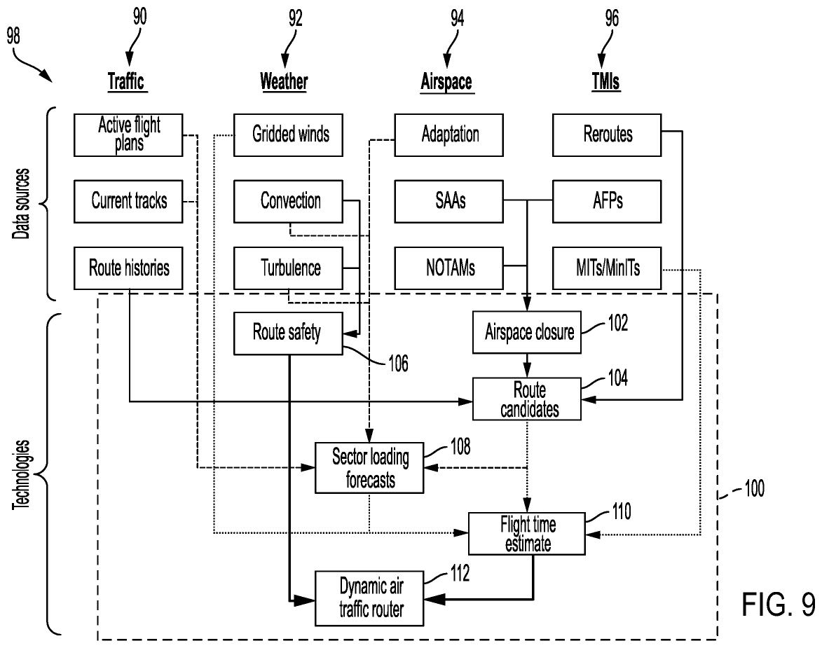

In order to identify the currently available routing options for a given flight, a first step is to identify all relevant airspace closures. FIG. 9 illustrates the four major information and data sources (traffic 90, weather 92, airspace 94, and TMIs 96) discussed above, and the key data types 98 within each source. FIG. 9 also shows how the dynamic air traffic rerouting technology herein identifies airspace closures, given that information and data. Specifically, FIG. 9 shows that the airspace closure identifier uses data from the Airspace/SAAs, Airspace/NOTAMs, and TMIs/AFPs sources with one or more computer processing systems 100 in communication with the above discussed data sources. As explained above, the SAAs and NOTAMs typically may report on airspace that is closed for some time window, whereas AFPs typically regions of airspace that cause delays (in the form of EDCTs). In other words, the airspace closure identifier deals with both hard and soft closures. A hard airspace closure occurs when flights are not allowed into the airspace. A soft airspace closure occurs when flights are subject to a possible delay, prior to entering the airspace. The airspace closure technology 102 reckons with and models both of these concepts. These are important when evaluating and advising route selection.

After the dynamic air traffic rerouting technology has identified airspace closures of all types, the system is then ready to identify the candidate routes 104 for a flight in the post-filing, pre-departure time window. This candidate route identifier technology is shown at 104 in FIG. 9, which shows that the candidate route identifier technology uses input data from both the airspace closure identifier as well as the traffic/route histories and TMIs/reroutes data sources. The traffic/route histories provide archived data from recent months, indicating which routes are typically flown for the given origin-destination (O-D) pair. On the other hand, the airspace closure and the TMIs/reroutes provide information regarding the current and pending restrictions, both in terms of airspace and in terms of specific routes.

The candidate route identifier technology 104 combines these information and data sources to determine the routes that are currently available. Specifically, each route that has been used on a reasonably frequent basis in recent months for this O-D pair is evaluated using the restrictions information to determine if the route (i) is not available due to a hard airspace closure or because alternate routing has been mandated, or (ii) may be subject to delay due to a soft closure. In the former case, routes that are not available are removed from the list. The remaining routes, along with their potential delay information, are retained to form the list of candidate routes.

An important criterion in the route selection decision is safety. Specifically, is there any inclement weather that could present hazards to a given route? As FIG. 9 shows at 106, the route safety assessment technology uses weather/convection and weather/turbulence data. The route safety assessment technology 106 uses current and forecasted convection and turbulence data to identify safety metrics (indicating different levels of hazardous flight) as a function of time, altitude, and geographic location. This resulting safety metric function may be used to evaluate the safety of any given candidate route. This function will be used in the route selection advisor.

As described above, there are several different types of TMIs that can influence a flight. For example, the flight may be subject to en route delay, en route rerouting, or pre-departure delay. A key criterion in routing decisions, particularly in the post-filing, pre-departure time window, is the likelihood that a route—either a current route that has been filed for the flight, or candidate reroutes, as discussed below—will be impacted by such a TMI. It is possible that such a TMI is already active or at least has been announced. But it also is possible that such a TMI does not yet exist, and has not been announced, but it will become active in time to impact a flight. It is important to forecast such imminent TMIs so that their impact may be avoided by prudent route selection.

A common cause, and good predictor, of such a TMI is airspace congestion in the national airspace system. Congestion may be caused by inclement weather (which degrades airspace capacity), high traffic volume, or some combination of the two. The system predicts such airspace congestion and uses these predictions in the TMI forecaster. The TMI forecaster, in turn, is used in the flight time estimator. The prediction of airspace congestion and use of that prediction in the TMI forecaster, as a leading indicator of future TMI impacts on a given candidate route, is a key innovation of the Dynamic Air Traffic Rerouting technology. As FIG. 9 shows, the system forecasts airspace congestion at the sector level with the sector loading forecasts 108. As FIG. 9 shows the system forecasts sector loading (108) using six information and data sources: (1) traffic/active flight plans (indicate routes and timing); (2) traffic/current aircraft tracks (indicate reconciliation problem); (3) weather/convection (indicate degraded sector capacity due to convection); (4) weather/turbulence (indicate degraded sector capacity due to turbulence); (5) airspace/adaptation (indicate the sector geometries); and (6) route candidates (indicate which routes and therefore airspace sectors are of interest).

The above list identifies the six information and data sources required by the sector loading forecast estimator technology 108. The parentheticals for each source describe the purpose of the data. Sources 3 and 4 above used previously developed airspace impact models that translate convection and turbulence observations into sector capacity degradations. Source 5 above provides the sector geometries (i.e., polygons describing the geographic shape and location of each sector). Source 6 above describes the candidate routes of interest for a given flight, and therefore the sectors of interest. Source 1 above is used to estimate the future traffic loading in each sector of interest. This estimate uses the flight plan of each flight to predict the flight's future trajectory. From the trajectory the system determines the flight's entry and exit times for each sector. Given the entry and exit times for all flights, and for all sectors, the system can determine the loading for each sector (i.e., number of aircraft inside the sector, as a function of time). The sector loading is then compared to the sector capacity, to determine if there are any congestion events.

Note that when using flight plans, the flight may currently be in the pre-departure or the post-departure phase. If in the pre-departure phase, there is increased uncertainty in the flight plan. This increased uncertainty is mainly due to the uncertainty in the exact departure time. For post-departure flights, this uncertainty is eliminated because the departure event has already occurred. There is, however, a different source of uncertainty for post-departure flights. This uncertainty arises when the flight fails to conform to its flight plan. Such a disparity is indicated by comparing the current, real-time, aircraft track with the corresponding flight plan. If the current aircraft position is not reasonably close to the flight plan, then the flight is declared to be non-conforming. In these scenarios, the differing (i) flight plan and (ii) track data, must be reconciled.

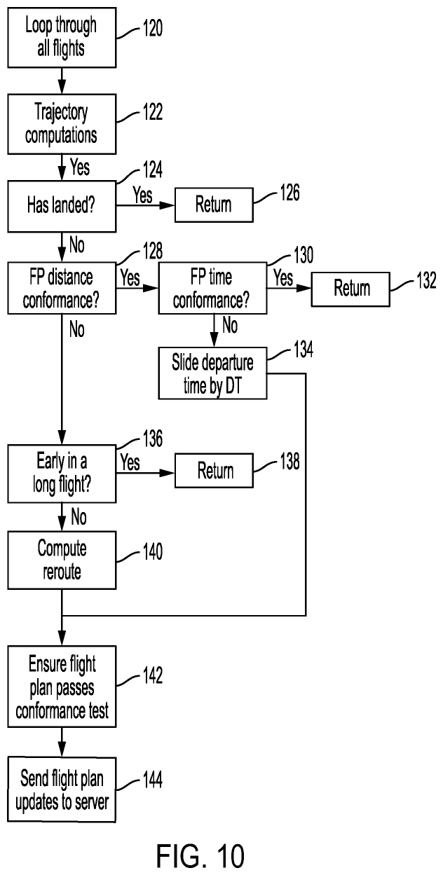

The final problem therefore in this sector loading forecast estimator technology 108 is to use sources 1 and 2 above to identify and resolve any reconciliation problems. At a high-level, the technology uses the following steps: detect non-conformance, including—cross track, altitude (detected via a distance discrepancy) and—in trail (detected via a time discrepancy); and modify flight plan to regain conformance, including—vertical plane (adjusted using changes to flight plan time, speed, or altitude), and—horizontal plane (adjusted using changes to flight plan route). FIG. 10 shows this reconciliation technology process, showing the flight plan versus aircraft track reconciliation technology.

In particular, FIG. 10 shows that the system will loop through all flights (step 120) and compute trajectories (step 122). Once these are determined, the system will for each flight determine whether the flight has landed (step 124) and if so, return (step 126) to above. If the flight has not landed (step 124), the system will perform flight plan distance confirmation (step 128). If this is confirmed, the system will confirm the flight plan time confirmation (step 130), and if this is confirmed the system will return (step 132) to above. If the flight plan time confirmation is not in conformance (step 134), the system will slide the departure time by a delay time (step 134). If the flight plan distance is not in conformance (step 128), the system will determine whether the aircraft is early in the flight (step 136), and if so, the system will return (step 138) to above. If the aircraft is not early in the flight (step 136), the system will compute a reroute (step 140). Once computed (step 140) or once a slide departure time is adjusted by a delay time (step 134), the system will ensure that the flight plan passes all conformance tests (step 142) and then send the flight plan updates to the server (step 144).

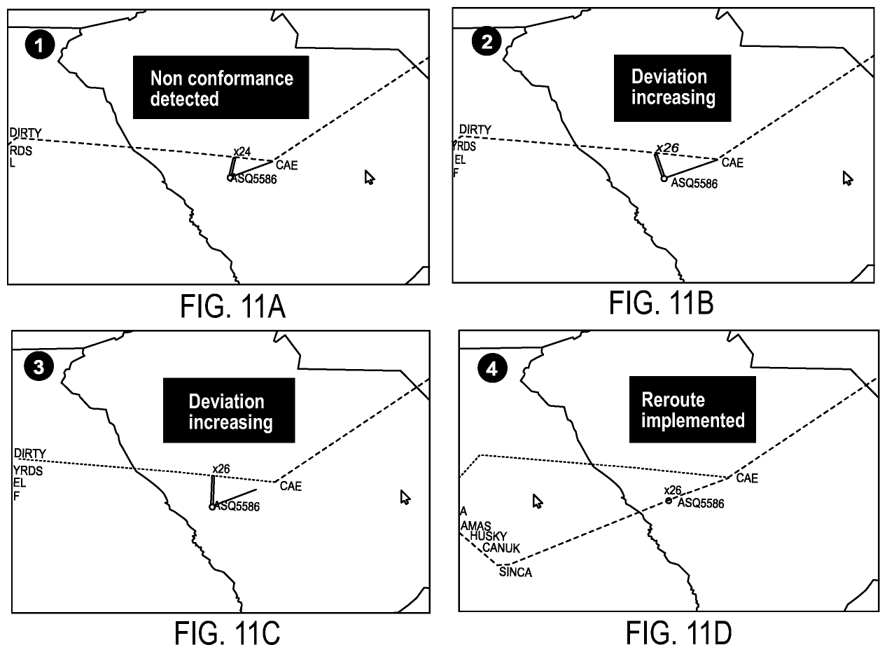

As an example, FIGS. 11A-11D show an arrival flight into ATL from the northeast that has been rerouted to the southeast arrival fix. The reconciliation technology detects the deviation from the original route (as shown in FIGS. 11A-11C) and constructs the correct route to the new fix (FIG. 11D). In particular, FIG. 11A shows the non-conformance detected, FIGS. 11B and 11C show the deviation increasing, and FIG. 11D shows the reroute implemented.

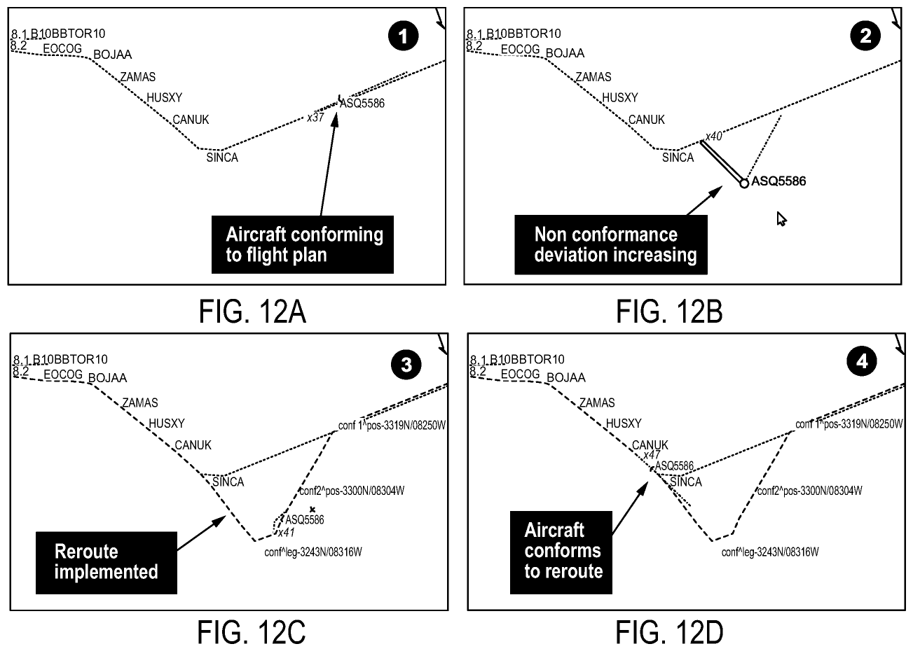

In another example, FIGS. 12A-12D show a flight subjected to path stretching, showing dog leg path stretch maneuver reroute. The flight turns to the south before reaching the arrival fix. The technology detects this deviation (shown in FIGS. 12A and 12B) and constructs a new route accordingly (FIG. 12C) which the flight follows (FIG. 12D). In particular, FIG. 12A shows the aircraft conforming to the flight plan, FIG. 12B shows a non-conformance deviation increasing, FIG. 12C shows a reroute implemented, and FIG. 12D shows the aircraft conforming to the reroute.

To summarize the reconciliation technology, aircraft tracking data are compared to the flight plan to determine if the aircraft is conforming to the flight plan. If not, the nature of the deviation is evaluated, and appropriate adjustments to the flight plan are made to remove the deviation. The new, modified, flight plan then replaces the old flight plan, and is used to predict the future aircraft trajectory, and sector entry and exit times.

In addition to the route safety assessed below, the other major consideration in route selection is flight time. As FIG. 9 shows, the flight time estimate technology 110 uses several different inputs, including gridded winds, sector loading forecasts, route candidates, and MITs/MinITs. Specifically, FIG. 9 shows that the flight time estimate uses as input the following information and data sources: (1) weather/winds (converts air speed to ground speed which is needed to compute travel time); (2) sector loading forecasts (a leading indicator of TMIs impacting flight time); (3) route candidates (indicates routes to evaluate, and any existing TMI delay); and (4) TMIs/MITs, MinITs (indicates delay currently applied to certain flights on a route).

From source 1, the winds, are required in the trajectory calculations and simulation that computes the flight time between any two points. From source 3 some routes may have estimated delays due to TMIs that are currently active. These delays are added to the estimated flight time. From source 4, active MITs and MinITs, provide additional delays that may impact some of the candidate routes. If there are such MITs and MinITs, then there delays also are added to the estimated flight time. Finally, from source 2, the sector loading forecasts, provide a leading indicator of potential TMIs that may be activated that impact the flight time of some of the routes. The dynamic air traffic routing technology therefore includes a TMI forecaster, based on the sector congestion forecast, which allows us to translate forecasted airspace (sector) congestion into forecasted flight delay.

Finally, the backend technology components culminate with the dynamic air traffic router decision support tool. This support tool takes as input the route safety metrics and the flight time estimates, for all candidate routes. Note that the route safety metrics and the flight time estimates ultimately are a function of all of the information and data sources, and earlier backend technology components. So, the dynamic air traffic router decision support tool also incorporates all the information and data sources, and earlier backend technology components. At this point, the dynamic air traffic router decision support tool is taking as input the two types of data most relevant in route selection: safety and efficiency (in the form of flight time). Safety cannot be compromised, and so serves as a constraint. Routes that are deemed unsafe are dropped from the list, leaving safe routes, which are ordered according to their flight times and presented to the user via the innovative frontend user display technology, presented below. The system operates using one or more compute processing systems in communication with the identified data sources and analysis systems.

The frontend technology that displays the routing data generated by the backend dynamic air traffic routing technology and interacts with the user to support real-time decision making is discussed below, beginning with the adoption of standard Internet search engine look and feel, and adopts standard search engine look and feel. The search fields required are the flight O-D pair, departure time, and aircraft type, and an optional field is the cruise altitude. When not entered, a default value based on aircraft type and flight distance is used. Whenever possible the user auto-populates the search fields by clicking on his flight of interest, in a separate application. Relevant data are pulled in from that application to auto-populate the field. Advanced searches are also supported, such as applying a priori routing restrictions (e.g., exclude or force an include of a particular navigational fix).

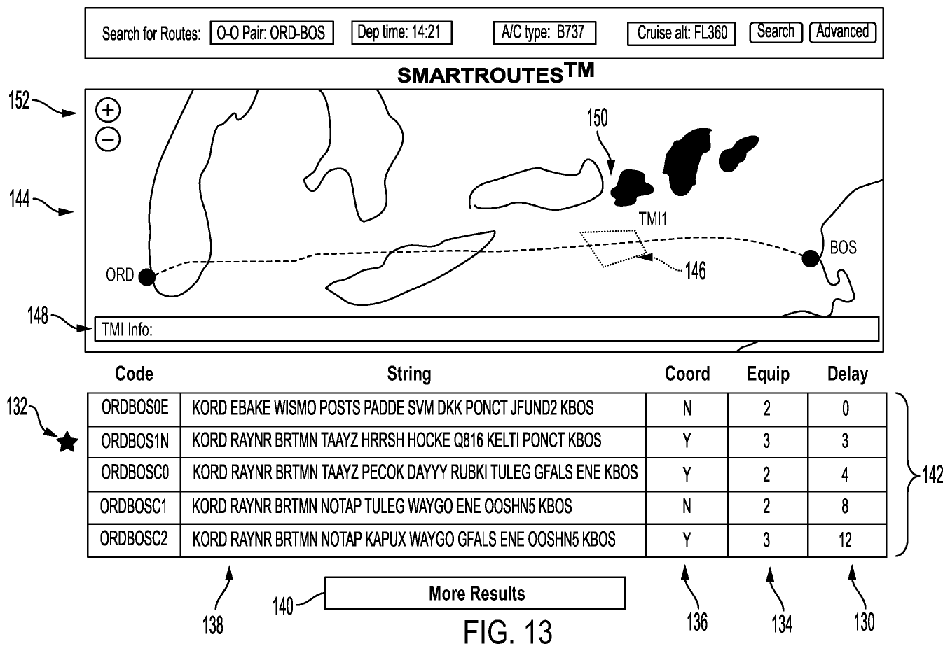

Next, FIG. 13 shows an example search result, for an ORD-BOS B737 flight, with cruise altitude of 36,000 ft. As FIG. 13 shows at 130, the delay column displays flight time for each candidate route, relative to the fastest route available, such that the entry is zero for the first route. Search results may be ordered by flight time, and the delay column may show delay in minutes relative to the fastest route. As FIG. 13 shows a 132, of the suggested routes that are displayed, one of them be selected. As shown in FIG. 13 (e.g., by use of a star), the user has selected the second route. Initially the first route is selected by default until the user selects a different route. FIG. 13 shows at 134, that the equipage column displays the code for the required equipage of each candidate route. For example, over-water flights have different equipage requirements that dispatchers and flight crews must be aware of. As FIG. 13 shows 136, the coordination column indicates whether ATC coordination is required in order to file for the candidate route. As FIG. 13 shows at 138 the route string is displayed for each candidate route. If the string is too long for the box, it may be truncated, or the box may use text-wrapping be scrollable. In any case, note that the route string may be copied for subsequent pasting into a different application, such as a flight planner. FIG. 13 shows at 140 that the top five routes are displayed, but the user may easily review the remainder of the routes by clicking the “More Results” button beneath the routes. Alternatively, the box 142 showing the five routes may be scrollable, to see the other candidate routes. FIG. 13 shows 144 that, above the route listings, a map displays the selected route. Alternatively, multiple routes or all five routes may be displayed, with the selected route highlighted on the map. FIG. 13 shows at 146 that, all impacting TMIs are graphically displayed on the map, for the selected route. Note that this example is notional and various TMI symbologies may be used. Note also that, by default, TMIs are not displayed if the flight altitude does not lie within the TMI altitude range.

As FIG. 13 shows at 148, the user may display the impacting TMIs detailed, textual information. For example, this information may be displayed in text box. This text box could be scrollable, so that information may be available for multiple TMIs. Alternatively, the user may select the TMI graphic by clicking on it, and right click to display a larger text box, providing the TMI information at a glance. As FIG. 13 shows at 150, the map also provides meteorological information. This includes real-time convection (shown) and wind vectors (including direction and elevation). By default, the wind at the cruise altitude is depicted, but the user may change this to another desired altitude, for example, for trial planning a flight plan change of cruise altitude. As FIG. 13 shows at 152, the map supports standard support functions such as zoom and pan.

Those skilled in the art will appreciate that numerous modifications and variations may be made to the above disclosed embodiments without departing from the spirit and scope of the present invention.

What is claimed is:

1. A method of providing a rerouting decision, said method comprising:
receiving a flight plan route for a flight between a starting location and a destination location;
confirming the flight plan route with an air traffic control system, said flight plan route being associated with a gate at the starting location;
receiving at least one candidate reroutes of the flight between the starting location and the destination location; and
accepting the at least one candidate reroute of the flight plan prior to leaving the gate at the starting location.

2. The method as claimed in claim 1, wherein the at least one candidate reroute is provided based on data from any of traffic, weather, airspace and traffic management initiatives information.

3. The method as claimed in claim 2, wherein the at least one candidate reroute is provided based on data from a weather information source that includes route safety data.

4. The method as claimed in claim 2, wherein the at least one candidate reroute is provided based on data from an airspace information source that includes airspace closure analyses.

5. The method as claimed in claim 2, wherein the at least one candidate reroute is provided based on data from a traffic management initiatives source that includes route candidates analyses.

6. The method as claimed in claim 1, wherein the at least one candidate reroute is provided based on sector loading forecast analyses.

7. The method as claimed in claim 1, wherein the at least one candidate reroute is provided based on flight time estimate analyses.

8. The method as claimed in claim 1, wherein the at least one candidate reroute is provided based on dynamic air traffic router analyses.

9. The method as claimed in claim 1, wherein the at least one candidate reroute of the flight between the starting location and the destination location is provided among a plurality of candidate reroutes of the flight between the starting location and the destination location.

10. The method as claimed in claim 1, wherein the method occurs in connection with a subject aircraft while the aircraft is at the gate.

11. A method of providing a rerouting decision, said method comprising:
confirming a flight plan route for an aircraft for a flight between a starting location and a destination location flight plan route with an air traffic control system, said flight plan route being associated with a gate at the starting location; and
receiving at least one candidate reroute of the flight between the starting location and the destination location prior to leaving the gate at the starting location.

12. The method as claimed in claim 11, wherein the at least one candidate reroute is provided based on data from any of traffic, weather, airspace and traffic management initiatives information.

13. The method as claimed in claim 12, wherein the at least one candidate reroute is provided based on data from a weather information source that includes route safety data.

14. The method as claimed in claim 12, wherein the at least one candidate reroute is provided based on data from an airspace information source that includes airspace closure analyses.

15. The method as claimed in claim 12, wherein the at least one candidate reroute is provided based on data from a traffic management initiatives source that includes route candidates analyses.

16. The method as claimed in claim 11, wherein the at least one candidate reroute is provided based on sector loading forecast analyses.

17. The method as claimed in claim 11, wherein the at least one candidate reroute is provided based on flight time estimate analyses.

18. The method as claimed in claim 11, wherein the at least one candidate reroute is provided based on dynamic air traffic router analyses.

19. The method as claimed in claim 11, wherein the at least one candidate reroute of the flight between the starting location and the destination location is provided among a plurality of candidate reroutes of the flight between the starting location and the destination location.

20. The method as claimed in claim 11, wherein the method occurs in connection with a subject aircraft while the aircraft is at the gate.

21. A system for providing a rerouting decision, said system comprising a computer processing system for confirming a flight plan route for an aircraft for a flight between a starting location and a destination location flight plan route with an air traffic control system, said flight plan route being associated with a gate at the starting location, and receiving at least one candidate reroute of the flight between the starting location and the destination location prior to leaving the gate at the starting location.

22. The system as claimed in claim 21, wherein the at least one candidate reroute is provided based on data from any of traffic, weather, airspace and traffic management initiatives information.

23. The system as claimed in claim 21, wherein the at least one candidate reroute is provided based on data from a weather information source that includes route safety data.

24. The system as claimed in claim 21, wherein the at least one candidate reroute is provided based on data from an airspace information source that includes airspace closure analyses.

25. The system as claimed in claim 21, wherein the at least one candidate reroute is provided based on data from a traffic management initiatives source that includes route candidates analyses.

26. The system as claimed in claim 21, wherein the at least one candidate reroute is provided based on sector loading forecast analyses.

27. The system as claimed in claim 21, wherein the at least one candidate reroute is provided based on flight time estimate analyses.

28. The system as claimed in claim 21, wherein the at least one candidate reroute is provided based on dynamic air traffic router analyses.
